(19) United States
(12) Patent Application Publication
(10) Pub. No.: US 2014/0025480 A1
(43) Pub. Date: Jan. 23, 2014

(54) Systems And Methods For Keyword-Based Traffic Refinement

(71) Applicant: Jason A. Carter, Lehi, UT (US)

(72) Inventor: Jason A. Carter, Lehi, UT (US)

(21) Appl. No.: 13/551,600

(22) Filed: Jul. 17, 2012

(51) Int. Cl. G06Q 30/02

(52) U.S. Cl. 705/14.43

(57) ABSTRACT

Methods and systems for keyword-based traffic refinement are disclosed. In one embodiment a plurality of queries entered at one or more search engines is received. In some embodiments, the plurality of queries are each a different query that was entered at the one or more search engines and resulted in one or more advertisements associated with the keyword being displayed in search results for the query. The analytics data comprises analytics data for a network site linked to the one or more advertisements, and pertains to network traffic received at the network site as a result of the one or more advertisements being activated. The analytics data is segmented by query for each of the plurality of queries and analyzed per query to determine one or more of the queries to use as an exact match keyword to modify the keyword-based search engine marketing campaign.

### BACKGROUND

Internet usage has grown significantly in recent years. Businesses often publish a website selling their products in addition to, or instead of, traditional brick and mortar locations to provide growth opportunities for their business. Internet search engines (e.g., Google™, Bing™, Yahoo!™) offer users the capability to search for websites on topics, products or businesses using one or more search terms, i.e., keywords. To increase the volume of traffic to their website, business owners create a Search Engine Marketing (SEM) campaign to bid on keywords that correspond to terms entered by users at a search engine. SEM campaigns include one or more advertisement groups with one or more advertisements and keywords. Businesses with a higher bid on a given keyword may have their advertisement corresponding to the keyword appear higher in the search results in response to user searches, thus giving the business high visibility to users of the search engine. For example, Google™ reports that one billion searches per day occur on their search engine. Thus, entities whose advertisements appear frequently on results pages of a search engine in response to user searches expect to achieve enhanced levels of visibility for their businesses.

To assist business owners managing their campaigns, search engines offer data for analyzing their respective SEM campaigns. For example, data reflecting the number of impressions and clicks for a given advertisement corresponding to a particular set of keywords may be provided. Impressions reflects the number of times the advertisement appeared in the search engine results in response to a user query. Clicks correspond to the number of times a user selected or activated the advertisements. In addition to tracking costs, other data provided by search engines may be keyword recommendations based on aggregate data from similar SEM campaigns.

However, while the data provides basic information regarding the campaign, there is not a direct method for optimizing the keywords or advertisements based on the performance of the keywords or advertisements in the SEM campaign. Thus, businesses can not effectively manage their keyword bid costs and refine the traffic to their website to ensure a high return on investment.

### SUMMARY

Various embodiments of methods and systems for managing keyword-based traffic refinement are presented. In some embodiments, a plurality of queries entered at the one or more search engines are received for a keyword used in a keyword-based search engine marketing campaign implemented at one or more search engines. In some embodiments the plurality of queries are each a different query that was entered at the one or more search engines and resulted in one or more advertisements associated with the keyword being displayed in search results for the query. In some embodiments analytics data for the one or more advertisements associated with the keyword are received. In some embodiments, the analytics data comprises analytics data for a network site linked to the one or more advertisements pertaining to network traffic received at the network site as a result of the one or more advertisements being activated. In some embodiments, the analytics data is segmented by query for each of the plurality of queries. In some embodiments, the analytics data per query is analyzed to determine one or more of the queries to use as an exact match keyword to modify the keyword-based search engine marketing campaign. In some embodiments, analyzing the analytics data segmented by query further comprises scoring the performance of each query based on the analytics data. In some embodiments, in response to a score for the query being above a performance threshold, the query is added as an exact keyword match in the keyword based search engine marketing campaign.

### BRIEF DESCRIPTION OF THE DRAWINGS

FIG. 1 illustrates a configuration that supports keyword-based traffic refinement, according to one embodiment.

FIG. 2 illustrates a configuration of a keyword-based traffic refinement manager, according to one embodiment.

FIG. 3 is a flowchart of a method for keyword refinement, according to one embodiment.

FIG. 4 depicts an analytics data report that is segmented according to keyword, according to one embodiment.

FIG. 5 is a flowchart of a decision process for keyword refinement based on analytics data segmented by query, according to one embodiment.

FIG. 6 is a flowchart of a method for keyword-based advertisement refinement, according to one embodiment.

FIG. 7 depicts an analytics data report that is segmented by advertisement to determine modifications to an advertisement, according to one embodiment.

FIG. 8 depicts a decision process for keyword-based advertisement refinement based on analytics data segmented by advertisement, according to one embodiment.

FIG. 9 is a flowchart of keyword-based traffic refinement, according to one embodiment.

FIG. 10 illustrates a computer system for use in implementing keyword-based traffic refinement, according to one embodiment.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. Headings used herein are for organizational purposes only and are not meant to be used to limit the scope of the description.

### DETAILED DESCRIPTION OF EMBODIMENTS

As discussed in more detail below, embodiments provide systems and methods for managing keyword-based traffic refinement. In some embodiments, for a keyword used in a keyword-based search engine marketing campaign implemented at one or more search engines, a plurality of queries entered at one or more search engines is received. The plurality of queries are each a different query that was entered at the one or more search engines and resulted in one or more advertisements associated with the keyword being displayed in search results for the query. In some embodiments, analytics data for the one or more advertisements associated with the keyword is analyzed. The analytics data includes analytics data for a network site linked to the one or more advertisements pertaining to network traffic received at the network site as a result of the one or more advertisements being activated. The analytics data is segmented by query, in some embodiments, for each of the plurality of queries. The analytics data per query is analyzed to determine one or more of the queries to use as an exact match keyword to modify the keyword-based search engine marketing campaign.

In some embodiments, for a keyword used in a keyword-based search engine marketing campaign implemented at one or more search engines, a plurality of queries entered at one or more search engines are received. The plurality of queries are each a different query that was entered at the one or more search engines and resulted in one or more advertisements associated with the keyword being displayed in search results for the query. In some embodiments, analytics data for the one or more advertisements associated with the keyword is received. The analytics data comprises analytics data for a network site linked to the one or more advertisements pertaining to network traffic received at the network site as a result of the one or more advertisements being activated. In some embodiments, the analytics data is segmented by advertisement for each of the plurality of advertisements. The analytics data per keyword is analyzed to determine advertisements that are candidates for new advertisement groups in the keyword-based search engine marketing campaign, in some embodiments.

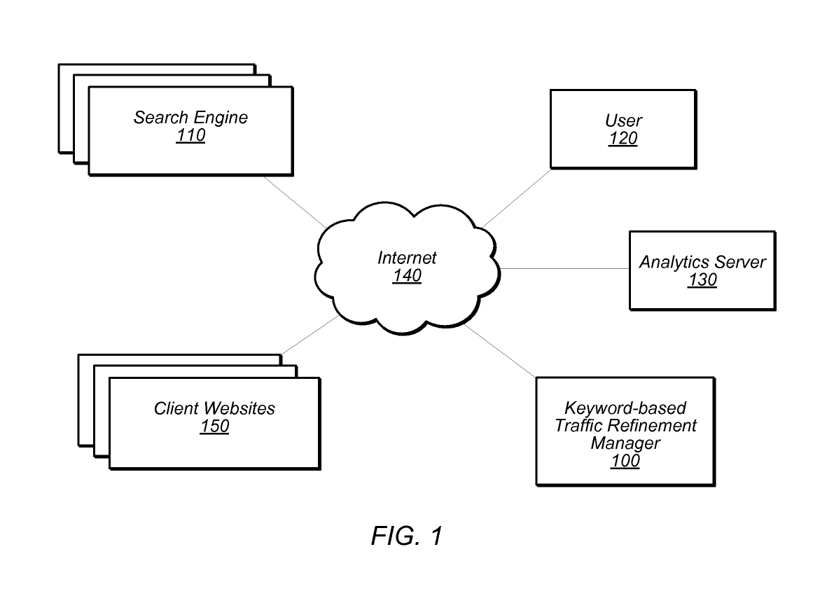

FIG. 1 illustrates a configuration that supports keyword-based traffic refinement, according to one embodiment. In general, a search engine 110 facilitates searches for information available on client websites 150. In response to a user 120 entering one or more terms, the search engine 110 displays results based on matching the terms in the query to keywords corresponding to text based advertisements from a keyword-based search engine marketing campaign. For example, entering “car dealership Austin Tex.” will result in a listing of car dealerships in the Austin, Tex. area. To improve their position in the advertising area of the search results, clients (e.g., owners of client websites 150) can implement and manage keyword-based search engine marketing (SEM) campaigns via keyword traffic refinement manager 100. The SEM campaigns use keyword bidding to determine which text based advertisements appear in the advertising area of search engine results. The text based advertisements include a link to the client website (e.g., client website 150). Analytics server 130 monitors client website 150 and provides the analytics data to keyword traffic refinement manager 100. In addition, keyword-based traffic refinement manager 100 receives analytics data from one or more search engines. In some embodiments, the keyword traffic refinement manager segments the analytics data according to advertisements and/or query per keyword. Keyword traffic refinement manager 100 determines scores for the performance of each advertisement and/or query based on the analytics data. Modifications based on the scores are then implemented in one or more search engine marketing campaigns.

In some embodiments, search engine 110 is configured to receive one or more terms from user 120 that facilitate locating information on client websites 150 corresponding to the terms. Search engines (e.g., Google™, Bing™, Yahoo!™) typically employ algorithms to attempt to identify websites available via internet 140. Data identifying these wesbsites is used to create a results listing independent of search engine marketing (SEM) campaigns. Search engine marketing (SEM) campaigns allow clients to increase the visibility of their website in the advertising area of search engine results. For example, most search engines reserve the upper portion and right side portion of the results page. Clients implement and manage their SEM campaigns via keyword-based traffic refinement manager 100. An SEM campaign includes one or more campaigns, each including one or more advertisement groups. Each advertisement group includes one or more advertisements and one or more keywords. For example, an advertisement group may include five advertisements and five hundred keywords corresponding to the client's product and/or service. In some embodiments, an advertisement is text based and includes a selectable link to client website 150. A keyword is a single word or a phrase that search engines match with user 120 queries (e.g., one or more terms entered at search engine 110) to determine the advertisement area of the search results. For example, a client selling dog products can choose keywords such as “dog”, “dog products”, “dog food” and/or any descriptive terms for the products they sell. Within the SEM campaign, these keywords and their corresponding bids are coupled to one or more advertisements that include client website 150. In response to a user entering terms at the search engine (e.g., search engine 110 in FIG. 1) that match one of the keywords described above, if the corresponding keyword bid is one of a group of selected (e.g., the top ten) bids, the advertisement corresponding to the keyword is displayed in the advertisement area of the results page. If user 120 selects the advertisement, user 120 will be directed to the client website 150.

In addition, keyword-based traffic refinement manager 100 receives data from search engine 110 for each SEM campaign. Examples of data provided by search engine 110 include, but are not limited to, clicks, impressions, cost of keyword bids and the queries that matched keywords in the SEM campaign. Impressions represent the number of times a given advertisement appeared in the advertising area of the search results. If user 120 clicks or selects the advertisement, that click or selection is recorded and user 120 is directed to client website 150 corresponding to the link. In some embodiments, both clicks and impressions affect the cost of the keyword bid.

In some embodiments, client websites 150 are implemented on one or more computing devices as part of an advertising campaign for the client and/or as a portal for selling products to wider customer base. It has been estimated that the number of individual websites numbers in the billions (e.g., as indexed by the Google™ search engine). A client website may be a single webpage viewable via a browser that offers basic information about a service with contact information (e.g., pest control, carpet cleaning, etc.), for example. A client website may be a retail website with multiple product web pages providing information about each product, respectively. Other non-limiting examples of client websites 150 are news sources, online magazines, blogs, apps on mobile devices, and/or social media websites.

In some embodiments, analytics server 130 determines client-side website metrics (e.g. of client websites 150). Analytics server 130 monitors all information for client website 150 once a user (e.g., user 120) selects client website 150. Analytics server 130 gathers this data for keyword-based traffic refinement manager 100. One non-limiting example of the data gathered is web traffic data indicating how user 120 arrived at the website. The web traffic data may include the search engine keyword, the queries, the search engine (e.g., Google™, Bing™, Yahoo!™) and the page ranking (e.g., a numerical value indicating the importance of a webpage). Other non-limiting examples are the revenue from each user 120 visit, and/or which SEM campaigns brought user 120 to client website 150.

In some embodiments, keyword traffic refinement manager 100 manages the keyword-based traffic refinement for a SEM campaign. Keyword traffic manager 100 receives analytics data from analytics server 130 and/or search engine 110. As discussed above, non-limiting examples of analytics data include impressions, clicks, cost of keyword bids, and/or the queries and the keyword in the SEM campaign that resulted in the display of the advertisement in the search results. With this analytics data, keyword refinement manager 100 calculates performance data such as click through ratio (CTR) and return on ad spending (ROAS). Examples of additional metrics that can be used as performance thresholds include cost per acquisition (CPA). The number of impressions represents the number of times a given advertisement appears in the search results of search engine 110. The number of clicks represents the number of times a given advertisement in the search results of search engine 110 is selected by user 120. The click through ratio (CTR) is determined by the ratio of clicks to impressions. The number can be indicative of the effectiveness of the advertisement. For example, if the advertisement has a high number of impressions, but low clicks, the resulting low CTR ratio may indicate poor relevance of the advertisement to the search results. The ROAS is determined by the ratio of revenue earned from the traffic directed to client website 150 by a given advertisement to the cost of bidding on the keywords corresponding to the given advertisement.

In some embodiments, keyword-based traffic refinement manager 100 scores the performance of a query or an advertisement based on the analytics data received in order to determine keyword-based traffic refinement. In some embodiments, keyword-based traffic refinement manager 100 segments the received data per keyword by queries received at search engine 110. The performance of each query is scored based on the analytics data. The performance is calculated by keyword-based traffic refinement manager 100. In some embodiments, keyword-based traffic refinement manager 100 segments the received analytics data by advertisement for a given keyword. The performance of each advertisement is scored based on the analytics data. In some embodiments, keyword-based traffic refinement manager 100 is configured to perform keyword-based traffic refinement for both queries and advertisement. In alternate embodiments, keyword-based traffic refinement for queries and advertisements are performed by separate systems configured as a keyword-based traffic refinement manager 100.

For example, a retail business selling clothing bearing a particular university logo may implement a website (e.g., client website 150). The website may have multiple webpages representing each product (e.g., jackets, hats, mugs, etc.) and be associated with a SEM campaign to improve visibility of the website. To optimize the traffic to the website, a keyword traffic refinement manager may analyze SEM campaign analytics data and determine modifications. The campaign may include an ad group for each product (e.g., jackets, hats, mugs, etc.) and within each ad group five ads depicting the respective product may be implemented. The ad group may further include one hundred keywords that represent one or more products. For example, the ad group with hats may include keywords such as “hats”, “baseball caps”, and/or other descriptive words describing the colors, team name, sizes etc in various combinations. After the campaign has been implemented, analytics data such as impressions, clicks, and the queries corresponding to the keywords are determined. The analytics data may be used to calculate CTR and ROAS and may be compared to a client-configured performance threshold for CTR and ROAS (e.g., in keyword-based traffic refinement manager 100). Modifications to the SEM campaign may be determined based on the threshold comparisons. For example, a particular advertisement for jackets may not receive any clicks and have low impressions, resulting in a CTR of zero. A modification may move the advertisement to a new advertisement group and implement one or more other keywords, for example. As another example, if the ROAS is higher than a client-configured performance threshold for a given query corresponding to a keyword, the query may be refined to a new keyword for the SEM campaign.

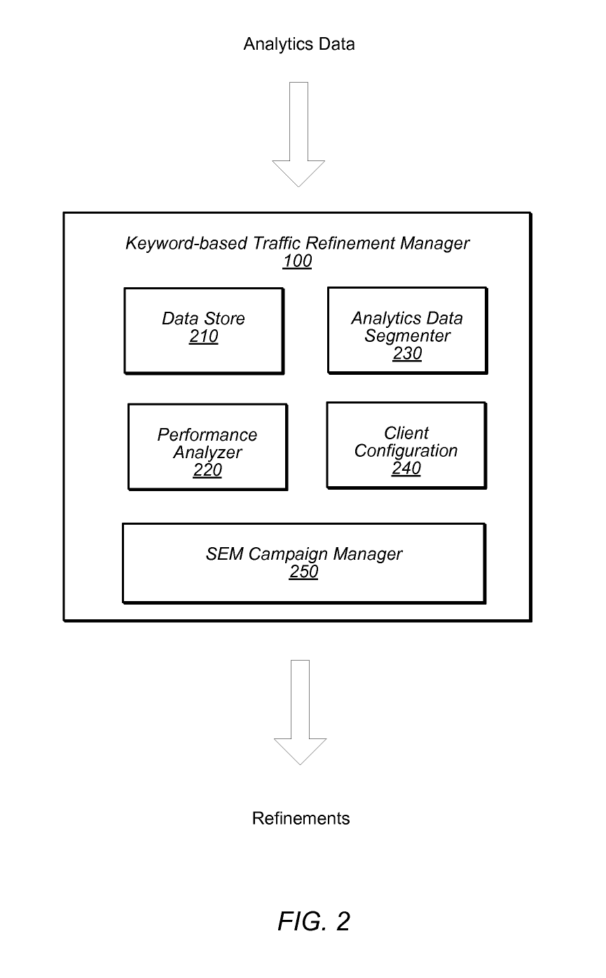

FIG. 2 illustrates a configuration of a keyword traffic refinement manager, according to one embodiment. As discussed above, keyword traffic refinement manager 100 receives analytics data from analytics server 130 and/or search engine 110. Keyword traffic refinement manager 100 segments the data (e.g., in analytics data segmenter 230) for each keyword by advertisement and/or query and stores the results in data store 210, in some embodiments. In some embodiments, keyword refinement manager 220 has a performance analyzer (e.g., performance analyzer 220) that calculates performance data (e.g., CTR, ROAS) for comparison to one or more performance thresholds. The performance thresholds are configured via a user interface in client configuration 240. In response to the calculated performance data exceeding one or more performance thresholds, SEM campaign manager 250 modifies the SEM campaign with new keywords and/or moves advertisements to new advertisement groups. In some embodiments, the SEM campaign is initiated via a user interface in client configuration 240 and implemented via SEM campaign manager 250.

In some embodiments, analytics data segmenter 230, receives the analytics data from an analytics server (e.g., analytics server 130) or from a search engine (e.g., search engine 110 in FIG. 1). Analytics data segmenter 230 segments the analytics data for each keyword by advertisement or query received at the search engine. As discussed above, queries are the one or more terms entered by the user (e.g., user 120 in FIG. 1) in a search engine (e.g., search engine 110 in FIG. 1) and keywords are the one or more terms in a SEM campaign. In response to a match between the query and the keyword, the advertisement corresponding to the keyword is displayed in the search engine results page. The segmented analytics data is received by performance analyzer 220. In some embodiments, performance analyzer 220 calculates performance data for a given query and/or advertisement per keyword based on the segmented analytics data received from analytics data segmenter 230. As an example, for a given keyword, the segmented analytics data may show five queries of interest. For each query, the impressions, cost, clicks, CTR, ROAS, and revenue may be displayed, where the CTR and ROAS are calculated for each query by performance analyzer 220. As another example, a particular keyword may be linked to five advertisements in one or more advertisement groups in a SEM campaign. For each of the five advertisements corresponding to the keyword, performance analyzer 220 may calculate the CTR and ROAS to score the performance for each advertisement.

In some embodiments, performance analyzer 220 scores the performance of each query based on the analytics data for each query. In some embodiments, performance analyzer 220 scores the performance of each advertisement based on the analytics data for each advertisement. Performance analyzer 220 retrieves performance thresholds from client configuration 240. In response to the score for the performance of the query being over a given threshold the query is added as a keyword in the keyword-based search engine marketing (SEM) campaign. For example, text of a query may be added as an exact match keyword in the SEM campaign of a respective search engine (e.g., search engine 110). In response to the score for the performance of a query being under a given threshold, the query is added as a negative match keyword. In response to the performance of an advertisement in relation to a subset of the keywords in the advertising group being above a given threshold, the advertisement and associated keywords may be moved to a new advertisement group. The performance analyzer may perform the above described analysis separately and in any order.

In some embodiments, SEM campaign manager 250 implements the changes determined by performance analyzer 220. As described above, in response to the performance of an advertisement in relation to a subset of the keywords in the advertising group being above a given threshold, the advertisement and associated keywords may be moved to a new advertisement group in the SEM campaign of a given search engine. SEM campaign manager 220 implements the changes in the search engine 110. As an example, as described above, in response to the score for the performance of the query being above a threshold, the query is extracted and implemented as a keyword in the SEM campaign. SEM campaign manager 220 implements the changes in the search engine 110. This will be discussed in more detail below.

Although the above described embodiment of the keyword-based traffic refinement manager 100 is configured to segment data by query or advertisement for given keyword, in alternate embodiments, the keyword-based traffic refinement manager 100 is implemented in separate systems. For example, a first system configured as a keyword-based traffic refinement manager 100 may segment the analytics data by query and a second system configured as a keyword-based traffic refinement manager 100 may segment the analytics data by advertisement for a given keyword.

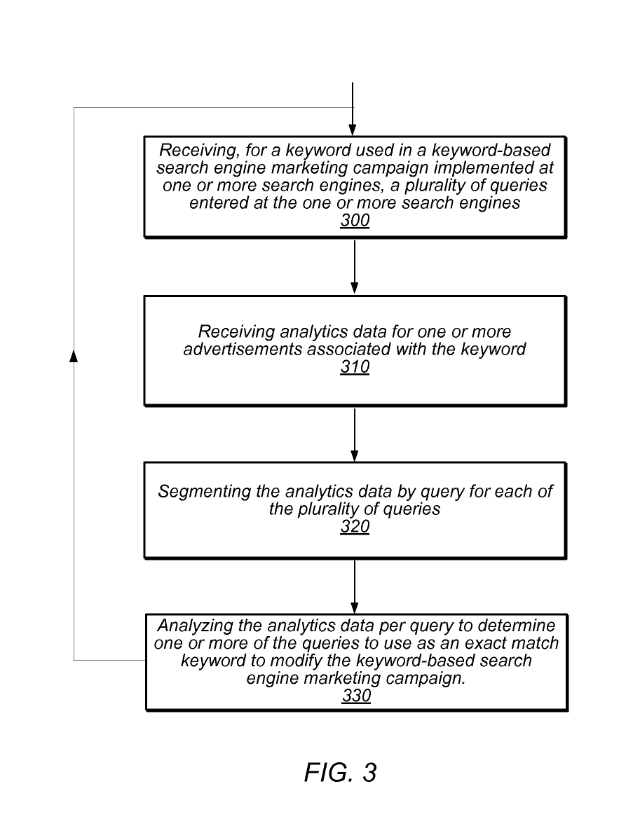

FIG. 3 is a flowchart of a method for keyword refinement, according to one embodiment. As described above, analytics data for a plurality of queries entered at one or more search engines (e.g., search engine 110 in FIG. 1) is received. The queries correspond to a keyword in the SEM campaign implemented in one or more search engines. In response to a given query matching a keyword in a given SEM campaign, the advertisement corresponding to the keyword displays in the search engine results. The bid on the keyword affects placement of the advertisement in the advertisement area of the search engine results. For example, if the advertisement is displayed in the advertisement area of the search engine results, the number of impressions is incremented. If a user (e.g., user 120) selects the advertisement to view the webpage corresponding to the uniform resource locator (URL) in the advertisement, the number of clicks is incremented. The data described above and other data is segmented per keyword by query and performance data is calculated (e.g., in performance analyzer 220 of keyword-based traffic refinement manager 100). The performance data is compared to a performance threshold to determine modifications to the keyword-based search engine marketing campaign. It should be noted that the above described analysis is completed per search engine in some embodiments. Queries may perform differently in each search engine and each search engine's SEM campaigns can have unique results due to the number of users and/or competitors bidding for the same keyword, for example.

As indicated in block 300, in some embodiments, for a keyword used in a keyword-based search engine marketing campaign implemented at one or more search engines, a plurality of queries entered at the one or more search engines is received. As discussed above, a query is one or more terms entered in a search engine (e.g., search engine 100 in FIG. 1) by a user (e.g., user 120 in FIG. 1). If the query is a match for a keyword in a search engine marketing campaign, the advertisement corresponding to the keyword appears in the search results of the search engine. The placement of the advertisement in the search engine results is based on the bid for the keyword and other factors such as a quality score (assessed by each search engine). For example, a keyword in an SEM campaign for a business selling dog products may be “dog” and the keyword match type may be broad. Beginning with a broad keyword match type will allow queries to have terms not directly matching the keyword in the query. For example, any query with “dog” in the one or more terms entered in the search engine (e.g., search engine 110 in FIG. 1) results in the advertisement corresponding to the keyword “dog” appearing in the search results. Due to the broad match keyword type, the queries that correspond to the keyword may be “dog supplies”, “DOG stock quote”, “World War II dog fights”, “dog treats”, “dog food” and/or “Dog and Goose Pub”. Users searching for “World War II dog fights” most likely will not select an advertisement for dog products. The business will incur costs for bidding on the keyword without gaining a new customer. In addition, several of the other queries do not relate to a dog products business, thus analysis to optimize the keywords is effective at directing traffic to the website due to advertisement relevance and is effective at managing costs of keyword bidding.

As indicated in block 310, in some embodiments, analytics data for the one or more advertisements associated with the keyword is received. As described above, for the broad keyword “dog” in a search engine marketing campaign, multiple queries match with the keyword, but not all are related. Analytics data is received (e.g. from search engine 110 or analytics server 130 in FIG. 1) from one or more search engines. Examples of analytics data include impressions, clicks and cost. As discussed above, impressions indicate the frequency of appearance for a given advertisement in the search results of a given search engine. As discussed above, clicks indicate the frequency of clicks received by a given advertisement displayed in the search results of a search engine. In response to a click, a user (e.g., user 120 in FIG. 1) is directed to the website listed in the advertisement. Cost indicates how much was actually paid for the keyword bid.

As indicated in block 320, in some embodiments, the analytics data is segmented by query for each of the plurality of queries. As discussed above, a keyword designated as a broad keyword match will have multiple queries that match the keyword. For a given keyword, the analytics data is segmented by the queries that matched with the keyword. In some embodiments, the segmented data may be sorted to highlight the highest quality queries or the lowest quality queries. To continue the example above, the business with the keyword “dog” will have data segmented by the following queries: “dog supplies”, “DOG stock quote”, “World War II dog fights”, “dog treats”, “dog food” and/or “Dog and Duck Pub”.

As indicated in block 330, in some embodiments, the analytics data is analyzed (e.g., by keyword-based traffic refinement manager 100 in FIG. 1) per query to determine one or more of the queries to use as an exact match keyword to modify the keyword-based search engine marketing campaign. The segmented analytics data is further analyzed to determine performance data such as click through ratio (CTR), cost per click (CPC) and return on ad spend (ROAS). This data along with data used to calculate the performance data will determine which query to use as an exact match keyword in the keyword-based search engine marketing campaign. To continue the example above, the queries “dog treats”, “dog food” and “dog supplies” may have resulted in a high CTR and/or ROAS. These queries can be added to a keyword-based search engine marketing campaign as exact keyword matches (e.g., by keyword-based traffic refinement manager 100 in FIG. 1). Identifying the keyword as an exact match ensures that only queries where all of the terms match the keyword results in the advertisement corresponding to the keyword appearing in the search results of the search engine (e.g., search engine 110). At this point the method returns to block 300.

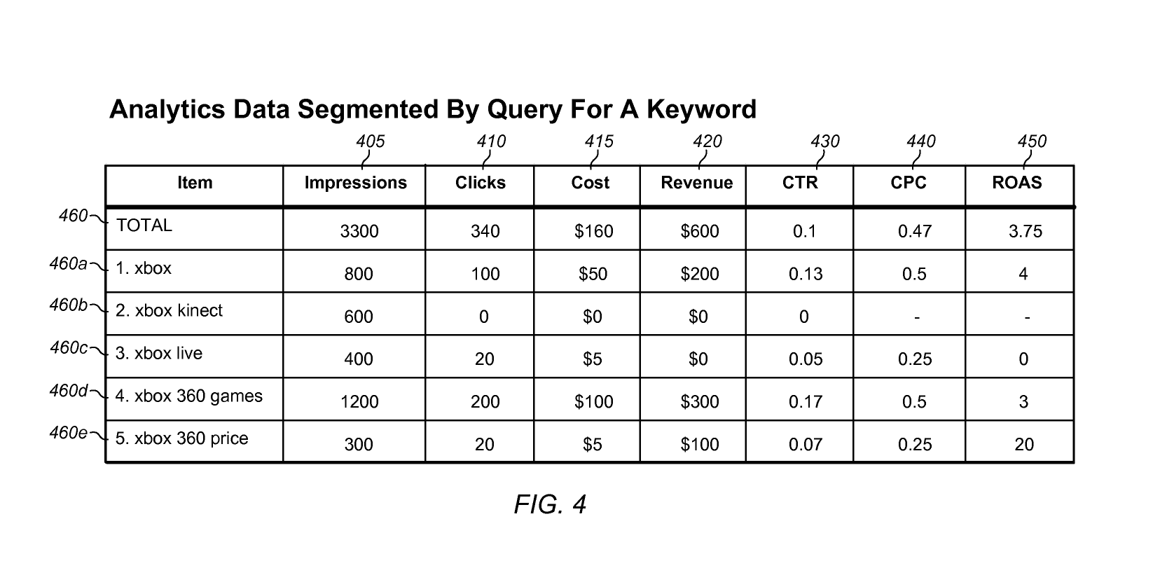

FIG. 4 depicts an analytics data report that is segmented according to keyword, according to one embodiment. As discussed above, in some embodiments, analytics data for a given keyword in a search engine marketing campaign is segmented by query (e.g., by keyword-based traffic refinement manager 100 in FIG. 1). Each query represents one or more terms entered by a user in a search engine (e.g., search engine 110 in FIG. 1). As discussed above, the analytics data is gathered by an analytics server (e.g. analytics server 130 in FIG. 1) or received from the search engine (e.g., search engine 110 in FIG. 1). The analytics data can be used (e.g., by keyword-based traffic refinement manager 100 in FIG. 1) to calculate performance data such as CTR, CPC and ROAS. In some embodiments, this information is used to determine (e.g., by keyword-based traffic refinement manager 100 in FIG. 1) which queries become exact keyword matches in a search engine marketing campaign. In some embodiments, this information is used to determine (e.g., by keyword-based traffic refinement manager 100 in FIG. 1) which queries become negative exact keyword matches in a search engine marketing campaign.

As depicted in FIG. 4, the analytics data and the performance analytics data has been segmented according to queries. As discussed above, the queries 400 are one or more terms received at a search engine (e.g. search engine 110 in FIG. 1) which are analyzed per keyword (e.g., by keyword-based traffic refinement manager 100 in FIG. 1). Each query has corresponding analytics data such as impressions 405, clicks 410, cost 415 and revenue 420. The analytics data may be received from an analytics server that gathers client website (e.g., client websites 150 in FIG. 1) data. In addition, search engine (e.g., search engines 110 in FIG. 1) data is received by a keyword-based refinement manager (e.g., keyword-based refinement manager 110 in FIG. 1). For example, the revenue may be determined from the client website analytics data. The analytics server (e.g. analytics server 130 in FIG. 1) monitors the traffic from a given search engine and determines the revenue due to that traffic. The analytics server can track a user's (e.g., user 120 in FIG. 1) entry into the website (e.g. client website 150 in FIG. 1) and follow the path to the point of purchase to determine the revenue, in some embodiments. As another example, the impressions may be received from the search engine (e.g., search engine 110 in FIG. 1). The impressions reflect the number of times an advertisement corresponding to a given keyword appears in the advertising area of the search engine results in response to the query 400.

As discussed above, the performance data for each query is determined (e.g., by keyword-based traffic refinement manager 100) based on the analytics data. As depicted in FIG. 4, the CTR 430 (e.g., click through ratio), CPC 440 (cost per click) and ROAS 450 (return on ad spend) were calculated. As discussed above, the CTR 430 is determined by the ratio of clicks 410 to impressions 405. The CPC 440 is calculated by the ratio of cost 415 to clicks 410. The ROAS 450 is calculated by the ratio of revenue 420 to cost 415 (e.g., cost of the keyword bid). In addition, the total 460 reflects the overall analytics data for the broad match keyword that corresponds to the queries 400. In some embodiments, calculated performance data is compared to a given performance threshold that is configured via a user interface (e.g. in client configuration 240 in FIG. 2)

In this example, the performance thresholds may be determined by the overall performance data for the broad match keyword. As depicted in FIG. 4, the first query xbox 400a has ROAS 450, CTR 430 and CPC 440 comparable to ROAS 450, CTR 430 and CPC 440 for the broad match keyword 460. Since the performance of the first query xbox 400a is comparable to the performance of the broad match keyword, it is not added as an exact match keyword in the search engine marketing campaign.

The second query 400, xbox kinect 400b, had zero clicks 410 even though there were 600 impressions 405. Since there were zero clicks 410, xbox kinect 400b was not added as an exact match keyword. The query did not earn any revenue for the client website (e.g., client website 150), thus, in some embodiments, the query is added as an exact negative keyword match in the search engine marketing campaign (e.g., by keyword-based traffic refinement manager 100 in FIG. 1). An exact match negative keyword ensures that queries with the terms xbox kinect 400b will not match to the broad match keyword 460 in the search engine marketing campaign. This will change the number of impressions 405 in subsequent reports to zero and improve the overall CTR 430 for the broad match keyword 460 corresponding to queries 400.

The third query 400, xbox live 400c, has a low CTR 420 compared to the overall CTR 430 of the broad keyword 460. In addition, the ROAS 450 for xbox live 400c is zero. This means that even though there were 20 clicks 410, none of the clicks that directed users (e.g. users 120 in FIG. 1) to the website (e.g. client website 150) resulted in revenue 420. Thus both revenue 420 and ROAS 450 for xbox live 400c is zero. Since there were 20 clicks 410, cost 415 was incurred. To avoid wasting more money on the query 400, xbox live 400c is added as a negative exact match keyword in the search engine marketing campaign (e.g., by keyword-based traffic refinement manager 100 in FIG. 1). As discussed above, negative exact match keywords ensure that any query containing the exact terms xbox live and those terms only will not result in a keyword match in the search engine marketing campaign.

The fourth query 400, xbox 360 games 400d, has impressions 405 and clicks 410 comparable to the broad match keyword 460. However, the ROAS 450 was below the performance threshold of the broad match keyword 460 ROAS 450. The clicks 410 indicate that users (e.g., users 120 in FIG. 1) are selecting to view the website, but the users leave before purchasing anything. This affects the CPC 440, which is higher than the CPC 440 for the broad match keyword 460. The query may be added as an exact match keyword in the search engine marketing campaign (e.g., by keyword-based traffic refinement manager 100 in FIG. 1), but the keyword bid may be lowered to account for the low revenue 420 and thus low ROAS 450 for xbox 360 game 400d.

The fifth query 400, xbox 360 price 400e, has an ROAS 450 that is much higher than the ROAS 450 for the overall broad match keyword 460. An exact keyword match for the terms xbox 360 price 400e is added to the search engine marketing campaign (e.g., by keyword-based traffic refinement manager 100 in FIG. 1). In addition, due to the high ROAS, the keyword bid may be increased to ensure better placement in the search engine results for the given search engine (e.g., search engine 110 in FIG. 1).

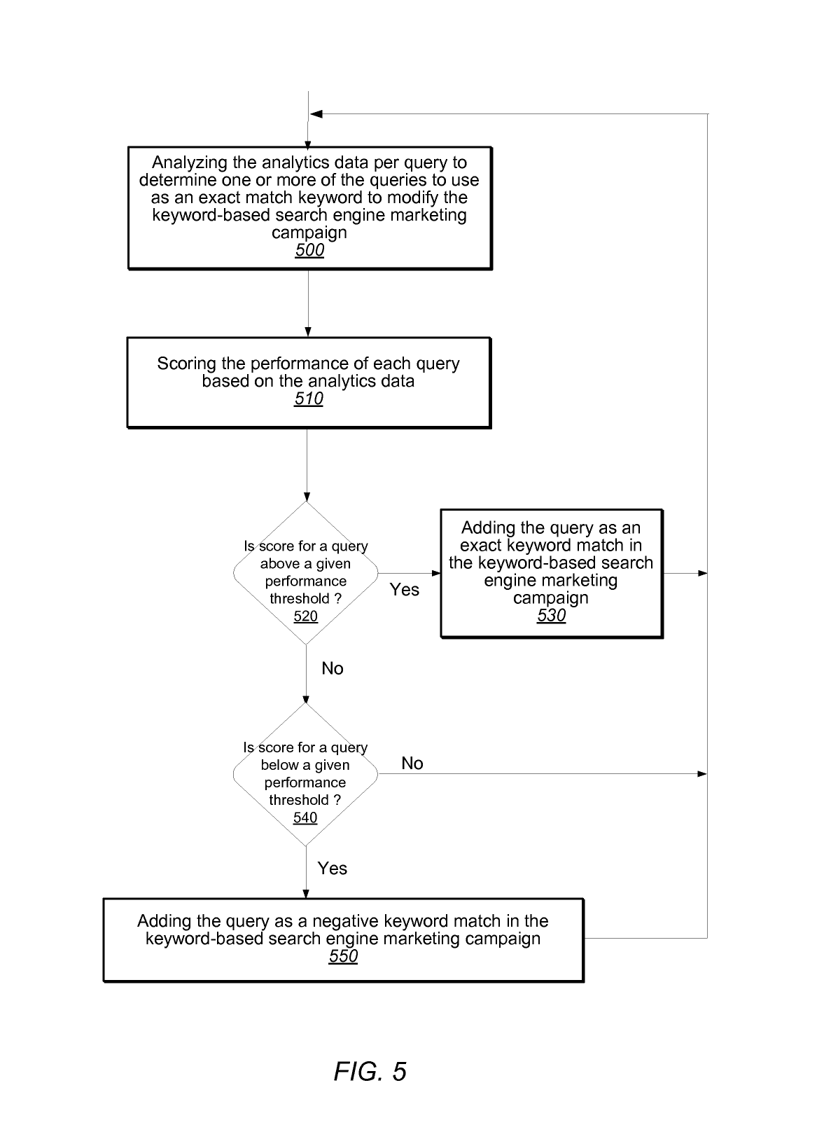

FIG. 5 is flowchart of a decision process for keyword refinement based on analytics data segmented by query, according to one embodiment. As discussed above, keyword refinement is a method for optimizing the keywords for a search engine marketing campaign. Queries received at a search engine (e.g., search engine 110 in FIG. 1) are matched to keywords in a search engine marketing campaign. The search engine marketing campaign is monitored and managed (e.g. by keyword-based refinement manager 100 in FIG. 1) for a given client website (e.g., client website 150 in FIG. 1). Analytics data is gathered from the search engine (e.g., search engine 110 in FIG. 1) and the client website (e.g., client website 150 in FIG. 1) by analytics server 130 and a keyword-based marketing manager (e.g. keyword-based marketing manager 100 in FIG. 1) analyzes and segments the data per query prior to comparing the information to performance thresholds (e.g. in performance analyzer 220 in FIG. 2). Based on the result of the comparison to a performance threshold, keyword optimizations are implemented (e.g., by SEM campaign manager 250 in FIG. 2). In addition, in some embodiments, one or more SEM campaigns may be implemented in one or more search engines. The decision process below may be implemented for SEM campaign in one or more search engines.

As indicated in block 500, in some embodiments, the analytics data per query for a given keyword is analyzed to determine one or more of the queries to use as an exact match keyword to modify the keyword-based search engine marketing campaign. As discussed above, analytics data is received from an analytics server (e.g. analytics server 130 in FIG. 130) and a respective search engine (e.g. search engine 110 in FIG. 1) by a keyword-based traffic refinement manager 100. As described above, the received analytics data is segmented according to query (e.g., by keyword-based traffic refinement manager 100).

As indicated in block 510, in some embodiments, the performance of each query is scored based on the analytics data. As described above, examples of analytics data include impressions, clicks, revenue, and cost. The impressions reflect the number of times an advertisement corresponding to the keyword in a search engine marketing campaign appears in the advertisement area of the search results of a search engine (e.g., search engine 110 in FIG. 1) in response to a given query. The clicks reflect the number of times an advertisement corresponding to the keyword in a search engine marketing campaign is selected from the advertisement area of the search results of a search engine in response to a given query. The cost reflects the cost of the keyword bid corresponding to each time an advertisement is selected from the advertisement area of a search engine. The revenue is determined by the purchase made at a client website (e.g., client website 150 in FIG. 1) due to a user selecting the advertisement from the advertisement area of a search engine marketing campaign. The above described values are used to calculate data such as CTR (e.g., click through ratio), and ROAS (e.g., return on advertisement spent). As discussed above, CTR is calculated by the ratio of clicks to impressions. As discussed above, the ROAS is calculated by the ratio of the revenue to the cost of the keyword.

As indicated in block 520, in some embodiments, it is determined whether the score for a query is above a performance threshold. One or more of the scores calculated above for each query are compared to a performance threshold. If a score is above a threshold, then as indicated in block 530, the query is added as an exact keyword match in the keyword-based search engine marketing campaign. As discussed above, the keyword type affects which queries will match to the keyword. Search engine marketing campaigns typically adopt a broad to narrow approach. A broad keyword type will match to any query that contains at least one of the terms of the keyword, any of the terms in the keyword in any order, synonyms, related search and/or other relevant variations of the terms. Beginning with a broad match keyword ensures a large volume of website traffic from the advertisements displayed in the search engine results. This also becomes cost prohibitive since each click on the advertisement incurs the cost of the keyword bid. Based on the scores above, it may be determined that a keyword can be narrowed to an exact match keyword to focus more on traffic quality versus traffic volume to the website (e.g. client website 150 in FIG. 1). An exact match keyword requires that all terms of the query at the search engine (e.g., search engine 110 in FIG. 1) match the keyword before the advertisement corresponding to the keyword is displayed in the search engine results. In other embodiments, a broad match keyword is narrowed to a phrase match in response to determining the score for the query is above a threshold. If the keyword is a plurality of terms, then narrowing from a broad match keyword to a phrase match keyword ensures that only the phrase with the words in the exact order match to a query entered at a search engine.

As indicated in block 540, in some embodiments, it is determined if the score of a query is below a given performance threshold. If the score for a query is not below a given threshold, then at this point the next query is analyzed as indicated in block 500. If the score is below a given threshold, as indicated in block 550, in some embodiments, the query is added as a negative keyword match in the keyword-based search engine marketing campaign. Queries that include the negative keyword match terms will not cause the advertisement to appear in the search results. At this point the method returns to block 500.

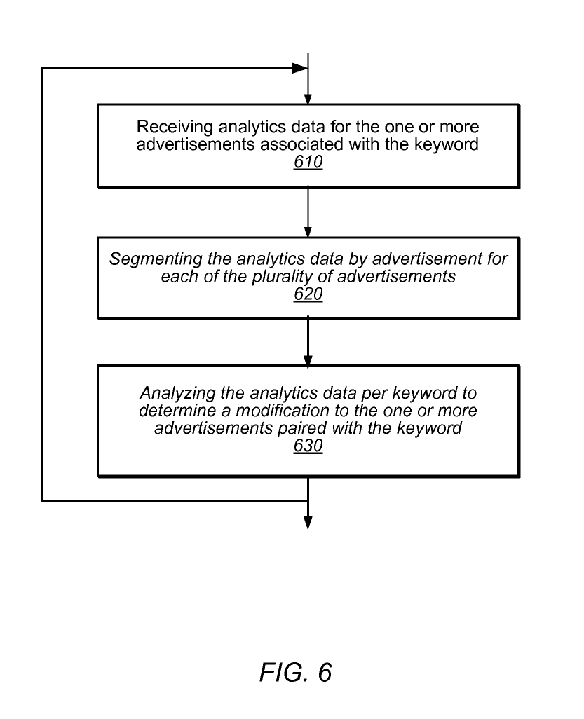

FIG. 6 is a flowchart of a method for keyword-based advertisement refinement, according to one embodiment. As discussed above, in general, search engine marketing campaigns include one or more advertisement groups. Within the one or more advertisement groups there are one or more advertisements and one or more keywords. For example, an advertisement group may include five advertisements and one hundred keywords. For each display of the advertisement in the search engine results analytics data is gathered (e.g., analytics server 130 in FIG. 1) from the client website (e.g., client website 150 in FIG. 1). In addition, analytics data is received from the search engine (e.g. search engine 110 in FIG. 1) by a keyword-based traffic refinement manager 100 in FIG. 1). In some embodiments a keyword-based traffic refinement manager (e.g., keyword-based traffic refinement manager 100 in FIG. 1) gathers the analytics data from the search engine and analytics server. For example, the impressions, clicks, and cost of the keyword bidding for each advertisement may be gathered. In some embodiments, the analytics data is segmented per keyword according to advertisement and the analytics data is analyzed to determine modifications to the advertisement. In some embodiments, the advertisement is moved to a new advertisement group with one or more different keywords.

As indicated in block 610, in some embodiments, analytics data for the one or more advertisements associated with the keyword is received. As discussed above, when an advertisement is displayed in response to a query entered at a search engine matching a keyword corresponding to the advertisement, analytics data is gathered. The analytics data may be revenue, impressions, and/or clicks. For example, if a user (e.g., user 120 in FIG. 1) selects an advertisement to view the website (e.g., client website 150 in FIG. 1) and then makes a purchase, this will count as revenue due to the advertisement. In addition, the display of the advertisement contributes to the number of impressions for the advertisement and the selection of the advertisement contributes to the number of clicks for the advertisement. In addition, the search engine, advertising campaign, advertising groups, and query, etc. can be gathered from either the website via an analytics server (e.g., analytics server 130 in FIG. 1) or from the search engine (e.g., search engine 110 in FIG. 1).

As indicated in block 620, in some embodiments, the analytics data is segmented by advertisement for each of the plurality of advertisements. As discussed above, the analytics data is received by a keyword-based traffic refinement manager (e.g., keyword-based traffic refinement manager 100 in FIG. 1). The analytics data is segmented by advertisement (e.g., in analytics data segmenter 230 in FIG. 2).

As indicated in block 630, in some embodiments, the analytics data per keyword is analyzed to determine a modification to the one or more advertisements paired with the keyword. The segmented analytics data is analyzed in a performance analyzer (e.g., performance analyzer 220 in FIG. 2) to determine a score for the advertisement. Based on the segmented analytics data, performance data such as CTR (click through ratio), ROAS (return on ad spend) and/or CPC (cost per click) is calculated. As discussed above, CTR is calculated by the ratio of clicks to impressions. As discussed above, the ROAS is calculated by the ratio of the revenue to the cost of the keyword. As discussed above, the revenue is determined by the purchase made at a client website (e.g., client website 150 in FIG. 1) due to a user selecting the advertisement from the advertisement area of a search engine marketing campaign. This will be discussed in further detail below. At this point the method returns to block 600.

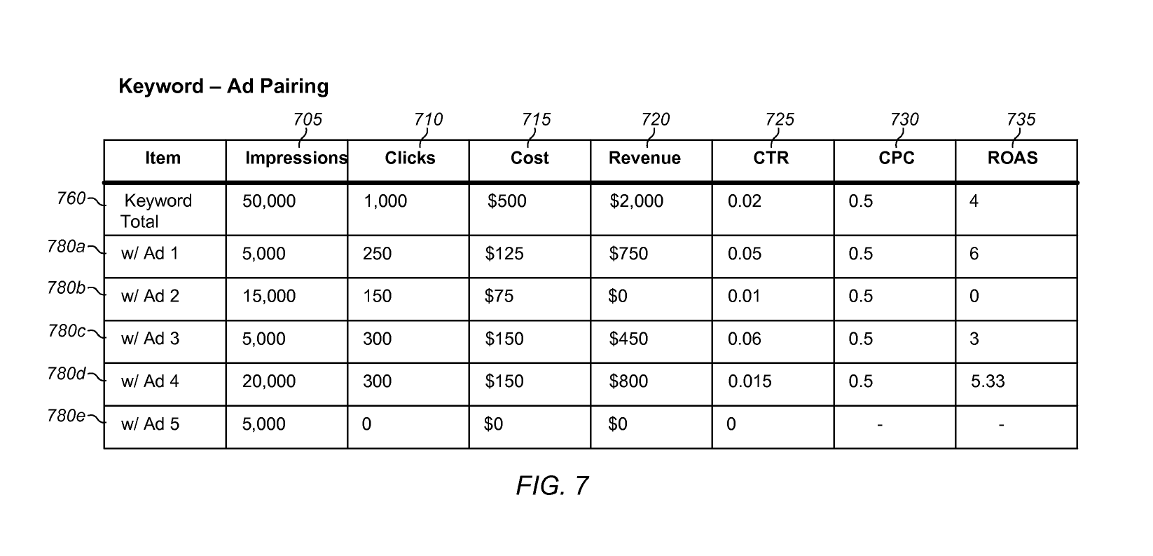

FIG. 7 depicts an analytics data report that is segmented by advertisement to determine modifications to an advertisement, according to one embodiment. As discussed above, the advertisements 700 are one or more advertisements displayed in the search engine results of a search engine (e.g. search engine 110 in FIG. 1), which are analyzed per keyword (e.g., by keyword-based traffic refinement manager 100 in FIG. 1). Each advertisement has corresponding analytics data such as impressions 705, clicks 710, cost 715 and revenue 720. The analytics data may be received from an analytics server that gathers client website (e.g., client websites 150 in FIG. 1) data or search engines (e.g., search engines 110 in FIG. 1). For example, the revenue may be determined from the client website analytics data. The analytics server (e.g. analytics server 130 in FIG. 1) monitors the traffic from a given search engine and determines the revenue due to that traffic. The analytics server can track a user's (e.g., user 120 in FIG. 1) entry into the website (e.g. client website 150 in FIG. 1) and follow the path to the point of purchase to determine the revenue, in some embodiments. As another example, the impressions may be received from the search engine (e.g., search engine 110 in FIG. 1). The impressions reflect the number of times an advertisement corresponding to a given keyword appears in the search engine results. As discussed above, the performance data for each query is determined (e.g., by keyword-based traffic refinement manager 100) based on the analytics data. For example, as discussed above, the CTR 725 (e.g., click through ratio) is the ratio of clicks 710 to impressions 705. The CPC (e.g., cost per click) 730 is the ratio of cost 715 to clicks 710. The ROAS (e.g., return on ad spend) is the ratio of revenue 720 to cost 715. The calculated performance data may be compared to one or more performance thresholds to determine modifications for one or more advertisements. In this example, the performance thresholds may be the overall performance data for keyword 760.

As depicted in FIG. 7, the Ad1 700a has a high CTR 725 and a high ROAS 735 and out performs the total CTR 725 and ROAS 735 for advertisements 700 corresponding to keyword 760. Since Ad1 exceeds the performance thresholds, the advertisement (e.g., Ad1 700a) should remain in the advertisement group with this keyword in a search engine marketing campaign.

However, Ad 2 700b and Ad5 700e have poor CTR 725 as compared to the CTR 725 of all the advertisements corresponding to the keyword. Ad2 700b has zero ROAS 735 and Ad5 700e has zero CTR 725. However, these advertisements are not deleted, because when paired with another keyword, the advertisements may perform better. Ad2 700b and Ad5 700e are moved to a new advertisement group with new keywords to determine a better pairing for these advertisements. This may help the cost 715 to convert to better ROAS and improve the quality score. The quality score is a factor determined by search engines (e.g., search engines 110 in FIG. 1) and it affects the amount that must be bid for each keyword to achieve the best placement in the search engine results. Although not directly depicted in FIG. 7, the quality score may be a factor in the decision process to determine which advertisements 700 should be moved to a new advertisement group (e.g., by keyword-based traffic refinement manager 100 in FIG. 1) in a search engine marketing campaign.

Advertisement Ad4 700d has a good ROAS 735 when compared to the overall advertisement ROAS 735 for the overall advertisements 700 for keyword 760. However, the CTR 725 is lower than the CTR 725 for keyword 760. The overall pairing of Ad4 700d with keyword 760 appears ideal due to the high ROAS 735, but due to the low CTR 725, the quality score described above may be affected. As discussed above, the quality score affects the bidding process for keyword 760. The threshold for the tradeoff between ROAS 735 and CTR 725 may be determined by the owner of the search engine campaign and configured in a keyword-based traffic refinement manager (e.g., keyword-based traffic refinement manager 100 in FIG. 1).

Advertisement Ad3 700c has a fair ROAS 735 when compared to the overall advertisement ROAS 735 for keyword 760. However, the CTR 725 is higher than the CTR 725 for keyword 760. The overall pairing of Ad3 700c with keyword 760 is not a clear decision due to the fair ROAS 735 and high CTR 725. The ROAS 735 may be marginal as determined by the performance thresholds in the client configuration but the quality score described above may be improved due to this keyword-advertisement pair. If the priority of the client is revenue 420, then the keyword-advertisement pairing may remain the same. If the priority of the client is cost 715 in addition to revenue 720, then Ad3 700c may be moved to a new advertisement group (e.g., by keyword based traffic refinement manager 100 in FIG. 1).

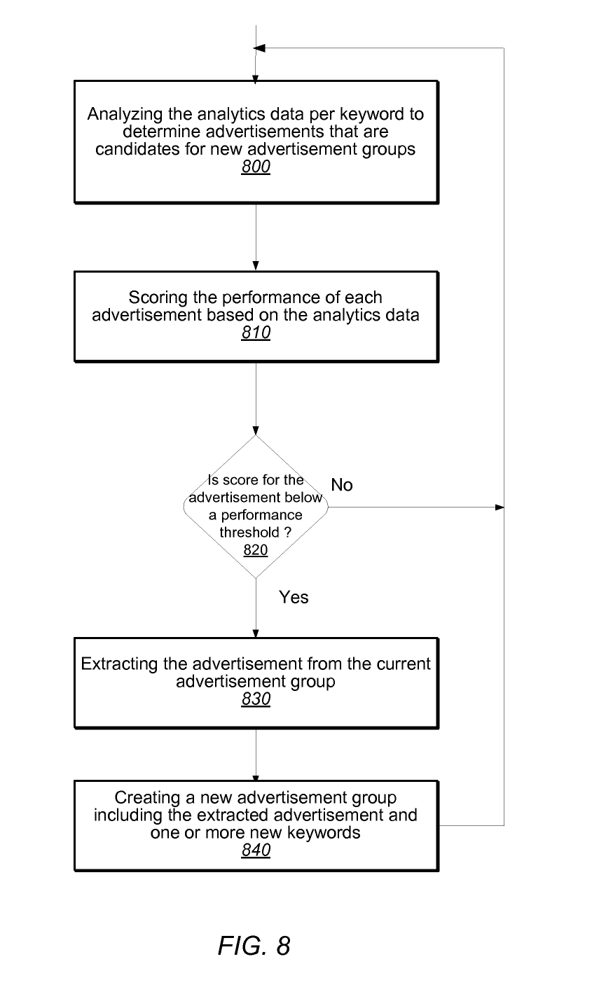

FIG. 8 depicts a decision process for keyword-based advertisement refinement based on analytics data segmented by advertisement, according to one embodiment. As discussed above, in response to queries at a search engine (e.g., search engine 110), keyword matches to the queries cause the advertisement corresponding to the keyword to display in the advertisement area of the search engine results. Each advertisement displayed in the advertisement area of the search engine results counts as an impression in the analytics data gathered (e.g., by keyword-based traffic refinement manager 100). If a user (e.g., user 120 in FIG. 1) selects the advertisement, the selection counts as a click and a keyword cost in the analytics data gathered. In addition, if a user makes a purchase after selecting the advertisement, the revenue corresponding to the purchase is recorded with the analytics data. The analytics data is used to determine a score for the advertisement. Based on the score, it is determined if the advertisement should remain in the advertisement group or be extracted for the current advertisement group and placed in another advertisement group.

As indicated in block 800, in some embodiments, the analytics data per keyword is analyzed to determine advertisements that are candidates for new advertisement groups. As described above, analytics data can be received from analytics servers monitoring client websites and/or search engines (e.g., search engine 110 in FIG. 1). Non-limiting examples of analytics data from a search engine include impressions and the cost of the keyword. As described above, the impressions represent the number of times an advertisement appears in the advertisement area of the search engine results. The cost of the keyword is determined by the bid on the keyword and other factors such as the quality score as determined by each respective search engine (e.g., Google™ Bing™, Yahoo!™) Non-limiting examples of analytics data gathered from a website (e.g., by analytics server 130 in FIG. 1) include the search engine that is the source of the traffic, the query, the keyword, the advertisement and/or the advertisement campaign.

As indicated in block 810, in some embodiments, the performance of each advertisement is scored based on the analytics data. The analytics data gathered from the website (e.g., client website 150 in FIG. 1) and the search engine (e.g., search engine 110 in FIG. 1) is received and further analyzed by a keyword-based traffic refinement manager (e.g., keyword-based traffic refinement manager in FIG. 1). The analytics data is used to calculate performance data such as CTR and ROAS in order to score the performance of each advertisement for a given corresponding keyword.

As indicated in block 820, in some embodiments, it is determined if the score for the advertisement is below a performance threshold. The score, as determined above, for the advertisement is compared to a performance threshold. The performance threshold is predetermined by the client (e.g. in client configuration 240 in keyword traffic refinement manager 100 in FIG. 2). In some embodiments, a performance threshold for each type of performance data is determined. For example, ROAS and CTR may each have a different threshold. If the score is not below a performance threshold, then the next advertisement is evaluated as indicated in block 800. In some embodiments, if the score is above a performance threshold, advertisement may be extracted from the current advertisement group and placed in a new advertisement group. For example, although the keyword and advertisement pairing is successful, a keyword bidding strategy or strategy for improving the quality score may determine whether the successful keyword and advertisement pairing should be in a new advertisement group. If the score is below a performance threshold, as indicated in block 830, in some embodiments, the advertisement from the current advertisement group is extracted.

As indicated in block 840, a new advertisement group including the extracted advertisement and one or more new keywords is created. A new advertisement group is created within a search engine marketing campaign for the advertisement. One or more keywords corresponding to the advertisement are added to campaign also. At this point, the method returns to block 800 to analyze the analytics data for the next advertisement.

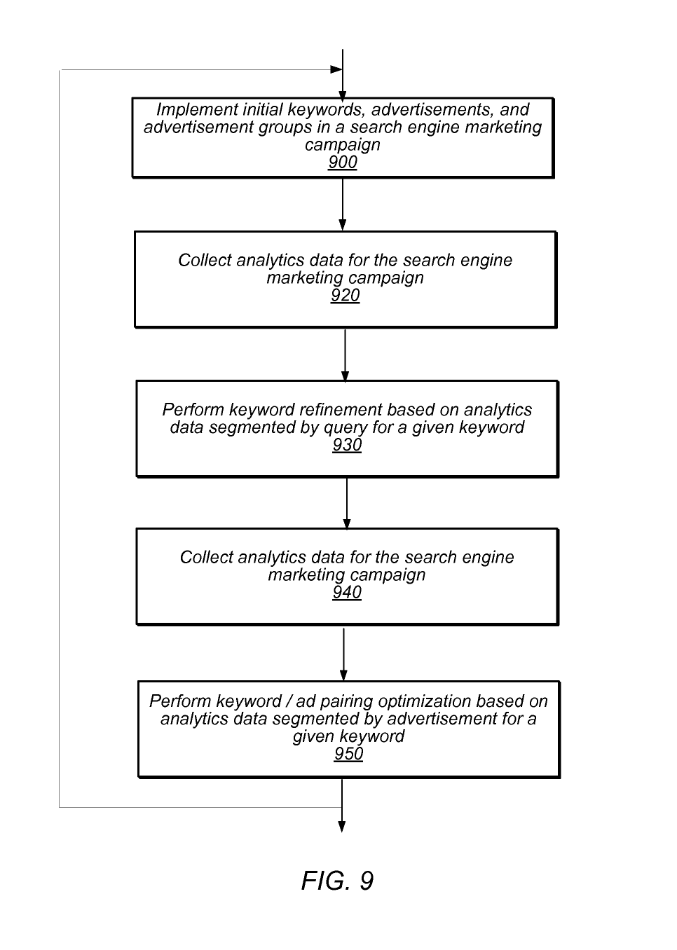

FIG. 9 is a flowchart of keyword-based traffic refinement, according to one embodiment. As discussed above, a search engine marketing (SEM) campaign is implemented (e.g. by SEM campaign manager 250 in FIG. 1) to improve the visibility of a client website (e.g., client website 150 in FIG. 1) via the keyword bidding process. As described above, the SEM marketing campaign includes one or more advertisement groups. Within each advertisement group there are one or more advertisements and one or more keywords corresponding to the advertisements. Once the SEM campaign has been implemented analytics data is collected and analyzed by query for a given keyword. The performance of each query is scored and keyword refinements are determined (e.g., by a performance analyzer 220 in keyword-based traffic refinement manager in FIG. 2). Once the refinements are determined (e.g., exact keyword match, negative keyword matches), they are implemented in the search engine marketing campaign (e.g., by SEM campaign manager 250 in keyword-based traffic refinement manager 100 in FIG. 2) After the keyword refinements are implemented, analytics data is collected again (e.g., via an analytics server 130 or from search engine 110 in FIG. 1). The analytics data is segmented and analyzed by advertisement for a given keyword (e.g., by a performance analyzer 220 in keyword-based traffic refinement manager in FIG. 2). The performance of each advertisement is determined and advertisements are moved to new advertisement groups in response to comparisons of the performance score to a threshold. The advertisement refinements are implemented (e.g., SEM campaign manager 250 in FIG. 2).

As indicated in block 900, initial keyword, advertisement, and advertisement groups are implemented for a search engine marketing campaign. As discussed above, a SEM campaign is implemented with one or more advertisement groups each including one or more advertisements and keywords. In response to a query entered at the search engine (e.g. by user 120 in search engine 110 in FIG. 1), a keyword match is determine. Based on the bid for the keyword, the placement of the advertisement in the advertising area of the search engine results is determined. In the initial campaign, the keyword match type is typically broad. A keyword that is a broad match keyword type will match with any query, regardless of order that has one or more terms of the keyword in it. It also matches on queries with related terms to the keyword. For example, in some embodiments, if the keyword is running shoes, then queries “running shoes”, “shoes running”, “red running shoes”, and “tips for running in shoes” will match. In addition, queries such as foot wear or runner stretches will also match on the keyword running shoes since the terms are related. However, beginning with broad match keywords attracts a high volume of website traffic (e.g., at client website 150 in FIG. 2) or a large number of impressions, but the quality of the matches will not be optimal. For example, for the keyword running shoes, the queries kid's shoes, women's dress shoes and/or men's dress shoes will match on the keyword. User's searching for shoes other than running shoes may not select the advertisement because the advertisement is not relevant to them. This impacts the CTR performance measurement. User's who select the advertisement for running shoes although they are looking for another type of shoes will most likely not purchase shoes, thus wasting the cost of the keyword bid and affecting other factors such as the quality score (e.g. as determined by respective search engines) and ROAS.

As indicated in block 910, analytics data for the search engine marketing campaign is collected. To refine the traffic received at the client website (e.g., client website 150 in FIG. 1), analytics data is collected and analyzed. The received data is segmented by query for a given keyword (e.g., analytics data segmenter 230 in FIG. 2). Each query is scored based on its analytics data (e.g., in performance analyzer 220 in FIG. 2). To score the query, performance data such as CTR and ROAS is calculated (e.g. in performance analyzer 220 in FIG. 2). The CTR is the ratio of clicks to impressions. The ROAS is the ratio of revenue from the advertisement to the cost of the keyword. The performance data for a given query is compared to a performance threshold. In some embodiments, the performance threshold is pre-configured by a client (e.g., client for client website 150 in FIG. 1 and stored in client configuration 240 in FIG. 2).

As indicated in block 920, keyword refinement is performed based on the analytics data segmented by query for a given keyword. In response to the comparison of the performance data for a given query being above a threshold, the query is extracted. The extracted query is then added to the SEM campaign (e.g., by SEM campaign manager 250 in FIG. 2) as an exact match keyword. As discussed above, an exact match keyword will only match a query is identical to the keyword string. Exact match keywords may not experience the same volume of impressions, but the CTR may increase due to the greater relevance to the query, for example. In response to the comparison of the performance data for a given query being below a threshold, the query is extracted. The extracted query is then added to the SEM campaign (e.g., by SEM campaign manager 250 in FIG. 2) as a negative match keyword. A negative match keyword causes queries that have terms matching the keyword to not display in the advertisement area of the search engine results. This process is completed for each query received in the analytics data.

As indicated in block 930, analytics data for the search engine marketing campaign is collected. In some embodiments, once the keyword refinement has been implemented, the keyword—advertisement pairing is optimized. Refining the keywords in the steps above causes the traffic to the website to be more relevant. The SEM campaign can be further optimized. For example, further optimization for each advertisement may improve the ROAS for the advertisement. As in block 910, the analytics data for the SEM campaign is received. The analytics data is the same as described in block 910, but for keyword—advertisement pairing the analytics data is segmented according to advertisement for a given keyword. Each advertisement is scored based on the analytics data for the advertisement. The score is determined by calculating the CTR and the ROAS which are calculated as described above (e.g. in performance analyzer 220 in FIG. 2). The calculated values are compared to performance thresholds (e.g., in client configuration 240 in FIG. 2) In some embodiments, clients predetermine the thresholds for the SEM campaign (e.g. in client configuration 240 in FIG. 2).

As indicated in block 940, keyword-advertisement optimization is performed based on the analytics data segmented by advertisement for a given keyword. In response to the performance data (e.g., the CTR and ROAS calculated in block 930) being below a performance threshold (e.g., as determined by a performance analyzer 220 in FIG. 2), the advertisement is extracted from the current advertisement group and placed in a newly created advertisement group. New keywords are added to the new advertisement group. In addition, if further analysis determines that the advertisement performs well with other current keywords in the SEM campaign, the current keywords are also added to the new advertisement group. This process is completed for each advertisement in the SEM campaign.

### Exemplary Computer System

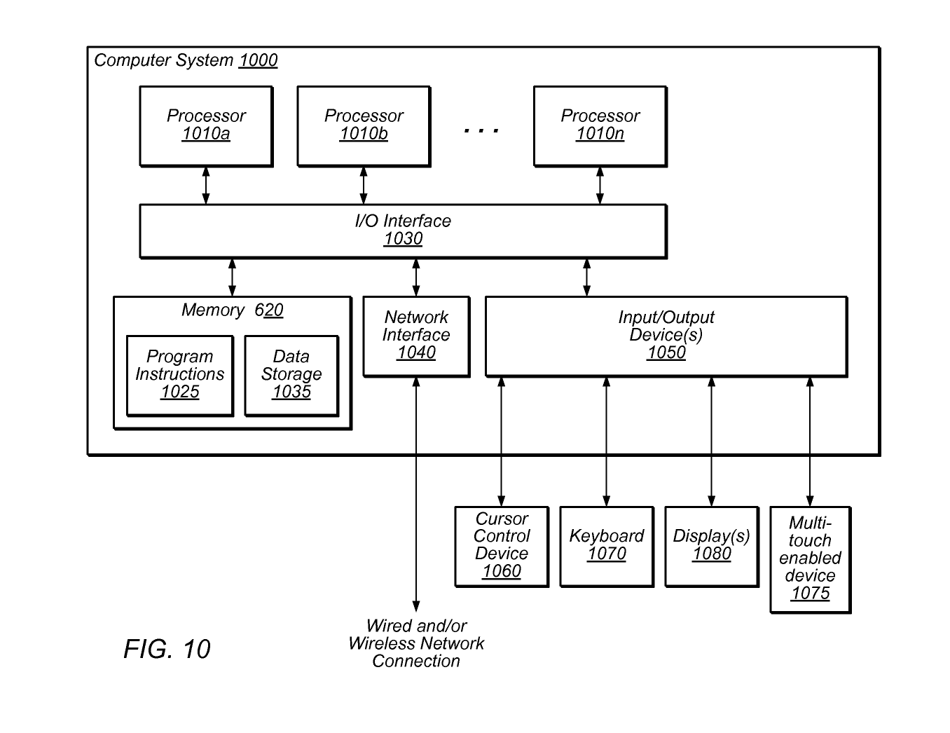

FIG. 10 is a diagram that illustrates an exemplary computer system 1000 in accordance with one or more embodiments of the present technique. Various portions of systems 100 in FIGS. 1-2 and/or methods presented in FIGS. 3-9 and/or described herein, may be executed on one or more computer systems similar to that described herein, which may interact with various other devices of the system. For example, content analyzer 120 may be executed on a processor in a computing device (e.g., computing device 100 in FIG. 1A)

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, audio device 1090, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit (GPU) may be considered a dedicated graphics-rendering device for a personal computer, workstation, game console or other computer system. GPUs may be very efficient at manipulating and displaying computer graphics and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the methods disclosed herein for layout-preserved text generation may be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies, and others.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for a layout-preserved text generation method, are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040. Program instructions may include instructions for implementing the techniques described with respect to methods depicted in FIGS. 3-4.

In some embodiments, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network (e.g., analytics server 130), such as other computer systems, or between nodes of computer system 1000. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, include one or more display terminals, keyboards, keypads, touchpads, scanning devices, voice or optical recognition devices, multi-touch screens, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040.

Memory 1020 may include program instructions 1025, configured to implement embodiments of a layout-preserved text generation method as described herein, and data storage 1035, comprising various data accessible by program instructions 1025. In one embodiment, program instructions 1025 may include software elements of a method illustrated in the above Figures. Data storage 1035 may include data that may be used in embodiments described herein. In other embodiments, other or different software elements and/or data may be included.

Those skilled in the art will appreciate that computer system 1000 is merely illustrative and is not intended to limit the scope of a layout-preserved text generation method as described herein. In particular, the computer system and devices may include any combination of hardware or software that can perform the indicated functions, including computers, network devices, internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations. In some embodiments, portions of the techniques described herein (e.g., analyzing analytics data) may be hosted in a cloud computing infrastructure.

Various embodiments may further include receiving, sending or storing instructions and/or data implemented in accordance with the foregoing description upon a computer-accessible medium. Generally speaking, a computer-accessible/readable storage medium may include a non-transitory storage media such as magnetic or optical media, (e.g., disk or DVD/CD-ROM), volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

Various modifications and changes may be to the above technique made as would be obvious to a person skilled in the art having the benefit of this disclosure. It is intended that the invention embrace all such modifications and changes and, accordingly, the above description to be regarded in an illustrative rather than a restrictive sense. While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. Any headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to. As used throughout this application, the singular forms “a”, “an” and “the” include plural referents unless the content clearly indicates otherwise. Thus, for example, reference to “an element” includes a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

What is claimed is:

1. A method, comprising:
performing by one or more computers:
receiving, for a keyword used in a keyword-based search engine marketing campaign implemented at one or more search engines, a plurality of queries entered at the one or more search engines, wherein
the plurality of queries are each a different query that was entered at the one or more search engines and resulted in one or more advertisements associated with the keyword being displayed in search results for the query;
receiving analytics data for the one or more advertisements associated with the keyword, wherein
the analytics data comprises analytics data for a network site linked to the one or more advertisements, and
the analytics data pertains to network traffic received at the network site as a result of the one or more advertisements being activated;
segmenting the analytics data by query for each of the plurality of queries; and
analyzing the analytics data per query to determine one or more of the queries to use as an exact match keyword to modify the keyword-based search engine marketing campaign.

2. The method of claim 1, wherein each of the one or more queries further comprises one or more terms.

3. The method of claim 1, wherein said receiving the plurality of queries comprises receiving queries from multiple search engines implementing the keyword-based search engine marketing campaign.

4. The method of claim 1, wherein said receiving analytics data for the one or more advertisements further comprises receiving, from an analytics server, a data indicating a number of impressions, clicks, revenue and cost corresponding to advertisements in a search engine marketing campaign.

5. The method of claim 1, wherein said analyzing the analytics data per query further comprises:
scoring a performance of each query based on the analytics data;
in response to a score for the query being over a performance threshold:
adding the query as an exact keyword match in the keyword-based search engine marketing campaign.

6. The method of claim 5, wherein said scoring the performance of each query comprises:
calculating a return on ad spent (ROAS) from the analytics data for each query;
wherein the ROAS is determined by a ratio of revenue to cost of the keyword; and
wherein the score for each of the plurality of queries is based on the ROAS for each query.

7. The method of claim 5, wherein said scoring the performance of each query comprises:
calculating a click through ratio (CTR) from the analytics data for each query;
wherein a click through ratio (CTR) is determined by a ratio of clicks to impressions; and
wherein the score for each query is based on the CTR for each query.

8. The method of claim 1, wherein said analyzing the analytics data per query comprises:
scoring a performance of each query based on the analytics data;
in response to a score for one or the queries being under a performance threshold:
adding the query as a negative keyword match in the keyword-based search engine marketing campaign.

9. The method of claim 1, wherein said analyzing the analytics data per query comprises:
scoring a performance of each query based on the analytics data;
in response to a score for one or the queries exceeding a performance threshold:
adding the query as a phrase keyword match in the keyword-based search engine marketing campaign.

10. The method of claim 1, wherein said analyzing the analytics data per query comprises:
scoring a performance of each query based on the analytics data;
in response to a score for one or the queries exceeding a performance threshold:
adding the query as a modified broad keyword match in the keyword-based search engine marketing campaign.

11. A system, comprising:
at least one processor; and
a memory comprising program instructions, wherein the program instructions are executable by the at least one processor to:
receive, for a keyword used in a keyword-based search engine marketing campaign implemented at one or more search engines, a plurality of queries entered at one or more search engines, wherein
the plurality of queries are each a different query that was entered at the one or more search engines and resulted in one or more advertisements associated with the keyword being displayed in search results for the query;
receive analytics data for the one or more advertisements associated with the keyword, wherein
the analytics data comprises analytics data for a network site linked to the one or more advertisements, and
the analytics data pertains to network traffic received at the network site as a result of the one or more advertisements being activated;
segment the analytics data by query for each of the plurality of queries; and
analyze the analytics data per query to determine one or more of the queries to use as an exact match keyword to modify the keyword-based search engine marketing campaign.

12. The system of claim 11, wherein the program instructions executable by the at least one processor to analyze the analytics data per query further comprises program instructions configured to:
score a performance of each query based on the analytics data;
in response to a score for the query being over a performance threshold:
add the query as an exact keyword match in the keyword-based search engine marketing campaign.

13. The system of claim 11, wherein the program instructions executable by the at least one processor to score the performance of each query further comprises program instructions configured to:
calculate a return on ad spent (ROAS) from the analytics data for each query;
wherein the ROAS is determined by a ratio of revenue to cost of the keyword; and
wherein the score for each of the plurality of queries is based on the ROAS for each query.

14. The system of claim 11, wherein the program instructions executable by the at least one processor to score the performance of each query further comprises program instructions configured to:
calculate a click through ratio (CTR) from the analytics data for each query;
wherein a click through ratio (CTR) is determined by a ratio of clicks to impressions; and
wherein the score for each query is based on the CTR for each query.

15. The system of claim 11, wherein the program instructions executable by the at least one processor to analyze the analytics data per query further comprises program instructions configured to:
score a performance of each query based on the analytics data;
in response to a score for one or the queries being under a performance threshold:
add the query as a negative keyword match in the keyword-based search engine marketing campaign.

16. The system of claim 11, wherein the program instructions executable by the at least one processor to analyze the analytics data per query further comprises program instructions configured to:
score a performance of each query based on the analytics data;
in response to a score for one or the queries exceeding a performance threshold:
add the query as a phrase keyword match in the keyword-based search engine marketing campaign.

17. The system of claim 11, wherein the program instructions executable by the at least one processor to analyze the analytics data per query further comprises program instructions configured to:
score a performance of each query based on the analytics data;
in response to a score for one or the queries exceeding a performance threshold:
add the query as a modified broad keyword match in the keyword-based search engine marketing campaign.

18. A non-transitory computer readable storage medium storing computer-executable program instructions that when executed by a computer are configured to cause:
receiving, for a keyword used in a keyword-based search engine marketing campaign implemented at one or more search engines, a plurality of queries entered at one or more search engines, wherein
the plurality of queries are each a different query that was entered at the one or more search engines and resulted in one or more advertisements associated with the keyword being displayed in search results for the query;
receiving analytics data for the one or more advertisements associated with the keyword, wherein
the analytics data comprises analytics data for a network site linked to the one or more advertisements, and
the analytics data pertains to network traffic received at the network site as a result of the one or more advertisements being activated;
segmenting the analytics data by query for each of the plurality of queries; and
analyzing the analytics data per query to determine one or more of the queries to use as an exact match keyword to modify the keyword-based search engine marketing campaign.

19. The non-transitory computer readable medium of claim 18, wherein the program instructions analyzing the analytics data per query further comprises program instructions configured to cause:
scoring a performance of each query based on the analytics data;
in response to a score for the query being over a performance threshold:
adding the query as an exact keyword match in the keyword-based search engine marketing campaign.

20. The non-transitory computer readable medium of claim 18, wherein the program instructions scoring the performance of each query further comprises program instructions configured to cause:
calculating a return on ad spent (ROAS) from the analytics data for each query;
wherein the ROAS is determined by a ratio of revenue to cost of the keyword; and
wherein the score for each of the plurality of queries is based on the ROAS for each query.

21. The non-transitory computer readable medium of claim 18, wherein the program instructions scoring the performance of each query further comprises program instructions configured to cause:
calculate a click through ratio (CTR) from the analytics data for each query;
wherein a click through ratio (CTR) is determined by a ratio of clicks to impressions; and
wherein the score for each query is based on the CTR for each query.

22. The non-transitory computer readable medium of claim 18, wherein the program instructions analyzing the analytics data per query further comprises program instructions configured to cause:
scoring a performance of each query based on the analytics data;
in response to a score for one or the queries being under a performance threshold:
add the query as a negative keyword match in the keyword-based search engine marketing campaign.

23. The non-transitory computer readable medium of claim 18, wherein the program instructions analyzing the analytics data per query further comprises program instructions configured to cause:
scoring a performance of each query based on the analytics data;
in response to a score for one or the queries exceeding a performance threshold:
adding the query as a phrase keyword match in the keyword-based search engine marketing campaign.

24. The non-transitory computer readable medium of claim 18, wherein the program instructions analyzing the analytics data per query further comprises program instructions configured to cause:
scoring a performance of each query based on the analytics data;
in response to a score for one or the queries exceeding a performance threshold:
adding the query as a modified broad keyword match in the keyword-based search engine marketing campaign.
